(19) United States
(12) Patent Application Publication
(10) Pub. No.: US 2026/0180917 A1
(43) Pub. Date: Jun. 25, 2026

(54) METHODS, ARCHITECTURES, APPARATUSES AND SYSTEMS FOR CONTROLLED SEGMENTATION AND TRAFFIC SHAPING

(71) Applicant: InterDigital Patent Holdings, Inc., Wilmington, DE (US)

(72) Inventors: Faris Alfarhan, Montreal (CA); Samuli Turtinen, Ii (FI); Paul Marinier, Brossard (CA)

(21) Appl. No.: 18/990,663

(22) Filed: Dec. 20, 2024

(51) Int. Cl. H04L 47/6275; H04L 47/22; H04L 47/62

(52) U.S. Cl. CPC H04L 47/6275; H04L 47/22; H04L 47/6215

(57) ABSTRACT

This disclosure relates to controlled segmentation and traffic shaping by a WTRU. The WTRU may receive, at a buffer associated with a data flow, a service data unit (SDU) of a first size. The WTRU may determine whether a level of a shaping bucket associated with the data flow is less than the first size. If the level of the shaping bucket is not less than the first size, the WTRU may allocate uplink (UL) resources of the WTRU for transmitting the SDU and transmit the SDU using the allocated UL resources. If the shaping bucket level is less than the first size, the WTRU may continue to store the SDU in the buffer.

### TECHNICAL FIELD

The present disclosure is generally directed to the fields of communications, software and encoding, including, for example, to methods, architectures, apparatuses, systems related to controlled segmentation and traffic shaping.

### BACKGROUND

Uplink (UL) Transport Block (TB) construction algorithms may involve unnecessary segmentation, resulting in increased computational complexity. Unnecessary segmentation in Media Access Control (MAC) of packets in a data flow may be avoided, for example, in delay tolerant scenarios. A Logical Channel Prioritization (LCP) algorithm is a multi-step resource allocation process, where in each step a round of allocation happens in order of Logical Channel (LCH) priority. If a packet in a data flow contains a larger number of bits than have been allocated for transmission, the packet will be segmented. The segmentation requires re-assembly at the receiver entity, delaying the overall delivery time to higher layers. As used herein, an allocated number of bits, a number of bits allocated to a bucket, a bucket size, bucket level, a bucket filling level, a shaping bucket, a bucket, a water level in a bucket, may referred to as Bj. Bj may represent a number of bits that can be buffered for a specific logical channel and/or data flow.

### SUMMARY

This disclosure is generally directed to the fields of communications, software and encoding, including, for example, to methods, architectures, apparatuses, systems related to controlled segmentation and traffic shaping. This disclosure may provide controlled segmentation and traffic shaping by a WTRU and/or a traffic scheduling regulator of a wireless transmit/receive unit (WTRU). The WTRU may receive, at a buffer associated with a data flow, a service data unit (SDU) of a first size. The WTRU may determine whether a level of a shaping bucket associated with the data flow is less than the first size. If the level of the shaping bucket is not less than the first size, the WTRU may allocate UL resources of the WTRU for transmitting the SDU and transmit the SDU using the allocated UL resources. If the shaping bucket level is less than the first size, the WTRU may continue to store the SDU in the buffer.

In some embodiments, the shaping bucket is a first shaping bucket and the level is a first level. The buffer may be one of a plurality of buffers each storing data associated with a plurality of respective data flows. Respective SDUs of the plurality of buffers may be of respective sizes that are greater than respective levels of respective shaping buckets associated with the plurality of data flows. The WTRU may (a) eliminate at least one data flow of the plurality of data flows based on at least one criterion. The WTRU may (b) allocate a second level of a shaping bucket associated with the eliminated at least one data flow to at least one shaping bucket of remaining data flows of the plurality of data flows causing a respective resultant level of the at least one shaping bucket of the remaining data flows to be greater than or equal to the respective sizes of the respective SDUs of the remaining data flows. The WTRU may (c) transmit SDUs associated with the at least one shaping bucket of the remaining data flows based on allocating the second level of the shaping bucket of the eliminated at least one data flow to the at least one shaping bucket of the remaining data flows.

In some embodiments, the at least one criterion comprises at least one of: data flow with least shaping bucket level, data flow with largest gap between its associated SDU size and shaping bucket level, data flow of least priority, or data flow with most remaining time with its associated data.

In some embodiments, the WTRU may repeat steps (a)-(c) until all SDUs associated with the plurality of data flows are transmitted without segmentation.

In some embodiments, continuing to store the SDU in the buffer comprises continuing to store the SDU in the buffer unless at least one condition is met. The WTRU may deliver at least a segment of the SDU to a MAC layer of the WTRU.

In some embodiments, the at least one condition comprises at least one of: a remaining time until expiration associated with the SDU exceeds a threshold, one or more conditions based on one or more quality of service (QoS) classes, the SDU is from a configured data flow, the SDU does not require segmentation at layers above the MAC layer, the first size is larger than a transport block size (TBS) of UL resources, a condition based on a type of data in SDU, or additional UL resources becoming available.

In some embodiments, the UL resources are first UL resources. The WTRU may allocate second UL resources of the WTRU to a MAC control element (CE) for transmitting the at least a segment of the SDU based on at least one additional condition.

In some embodiments, the at least one additional condition comprises at least one of: the MAC CE is of a certain type, the MAC CE is of a certain priority, the MAC CE is configured to be included regardless of segmentation implications, or an additional SDU would not be caused to be segmented by using the MAC CE for the SDU.

In some embodiments, continuing to store the SDU in the buffer comprises continuing to store the SDU in the buffer until the level of the shaping buffer is at least the first size.

In some embodiments, UL resources comprise bit allocation in a TB.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example WTRU that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is an illustrative uplink transmission scheme and an illustrative transmission timing diagram, according to some embodiments of this disclosure;

FIG. 3 is an illustrative bit traffic timing diagram, according to some embodiments of this disclosure;

FIG. 4 illustrates envelope shaping of data traffic, according to some embodiments of this disclosure;

FIG. 5 is an illustrative traffic shaping regulator, according to some embodiments of this disclosure;

FIG. 6 is an illustrative constrained traffic shaping regulator, according to some embodiments of this disclosure; and

FIG. 7 is an illustrative flow diagram of steps for controlled segmentation and traffic shaping, according to some embodiments of this disclosure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

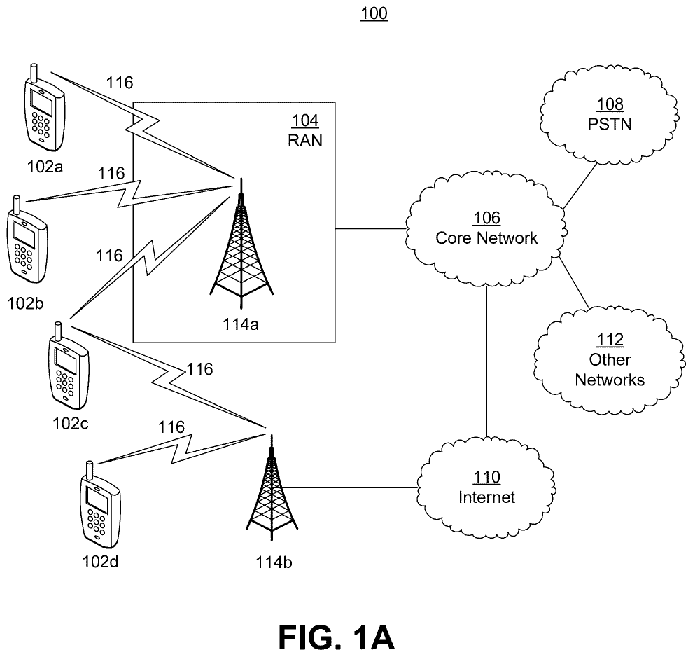

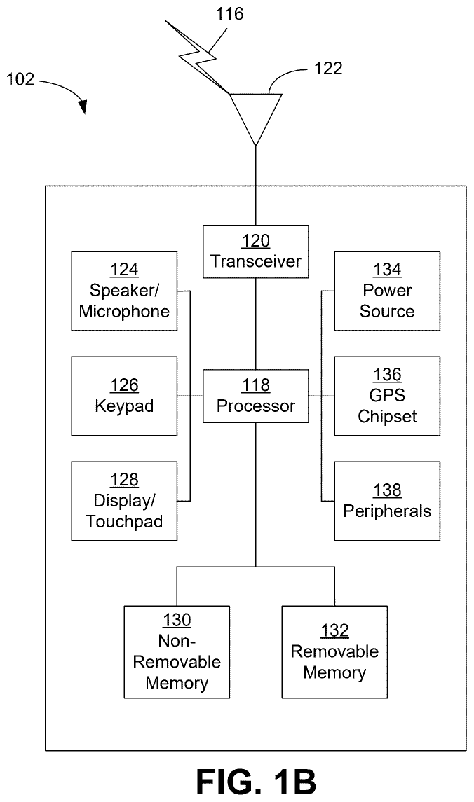

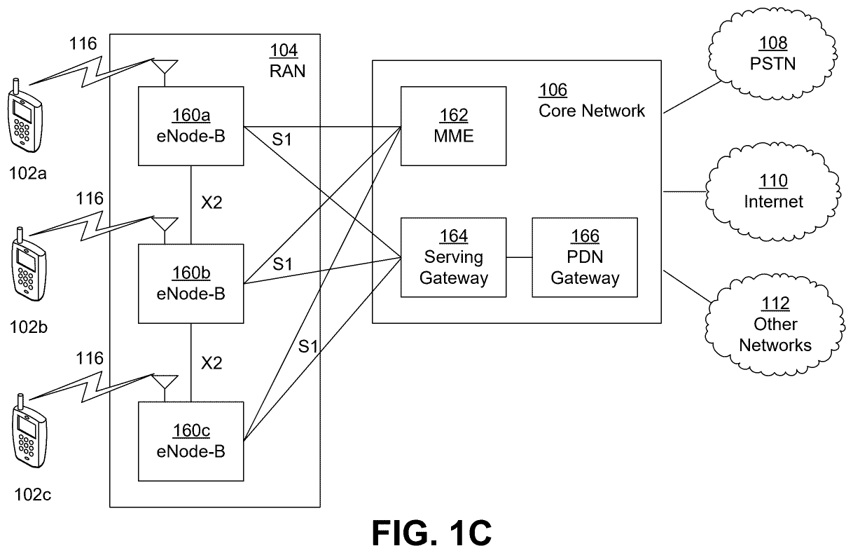

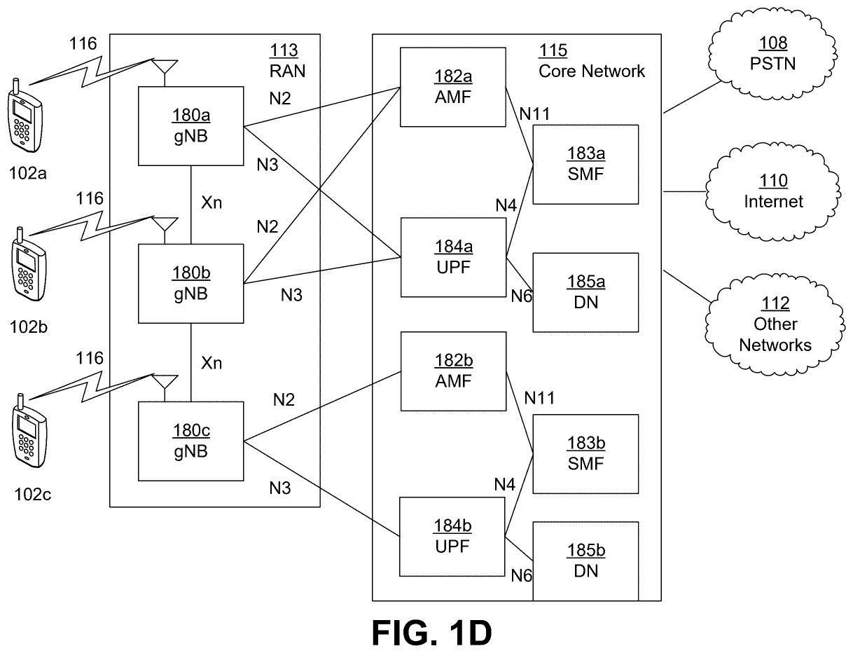

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying QoS requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the UL and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a MAC layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive da

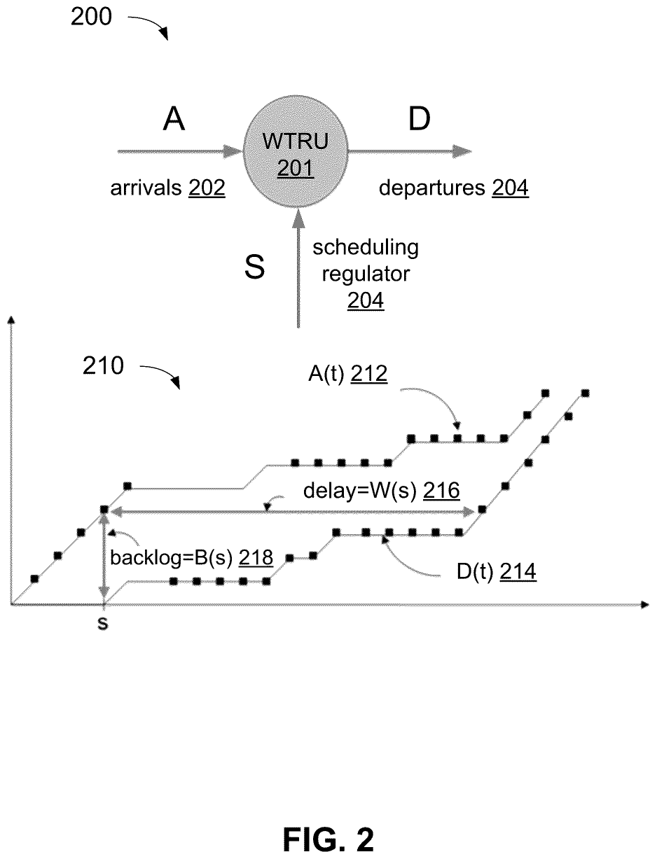

In accordance with some embodiments of this disclosure, the devices and systems of FIGS. 1A-1D may be used in connected with devices, systems, and methods for controlled segmentation and traffic shaping. For example, the devices and systems of FIGS. 1A-1D may be used in connection with the devices, systems, and methods described in FIGS. 2-7, in some embodiments of this disclosure.

In accordance with some embodiments of this disclosure, an illustrative uplink transmission scheme and an illustrative transmission timing diagram is shown in FIG. 2 and described as follows. Illustrative scheme 200 shows a WTRU 201 (e.g., WTRU 102) configured to receive data through arrivals 202 and send data through departures 204. Scheduling regulator 206 may govern a timing associated with receiving arrivals (A) 202 and/or transmitting departures (D) 204. During uplink transmission, the scheduling regulator(S) 206 may be used to characterize traffic transmission rates at WTRU 201. Scheduling regulator 206 may determine the worst-case bounds on delay and backlog in the WTRU's buffer. In FIG. 2, where A may describe the cumulative arrival function of traffic for a given flow to the WTRU's buffer and D may describe the transmission departure function from the WTRU's buffer to a scheduled grant. Illustrative timing diagram 210 may be associated with illustrative scheme 200. In some embodiments, the arrival function A(t) 212 may correspond to arrivals 202, and the departure function D(t) 214 may correspond to departures 204. A delay function, W(s) 216, characterizes the delay between when data arrives and when data is transmitted. At any condition s, there is a backlog that is characterized by backlog function b(s) 218. The backlog corresponds to how far behind (e.g., in unit intervals, or in absolute or relative time) data of the departure function is with respect to data of the arrival function.

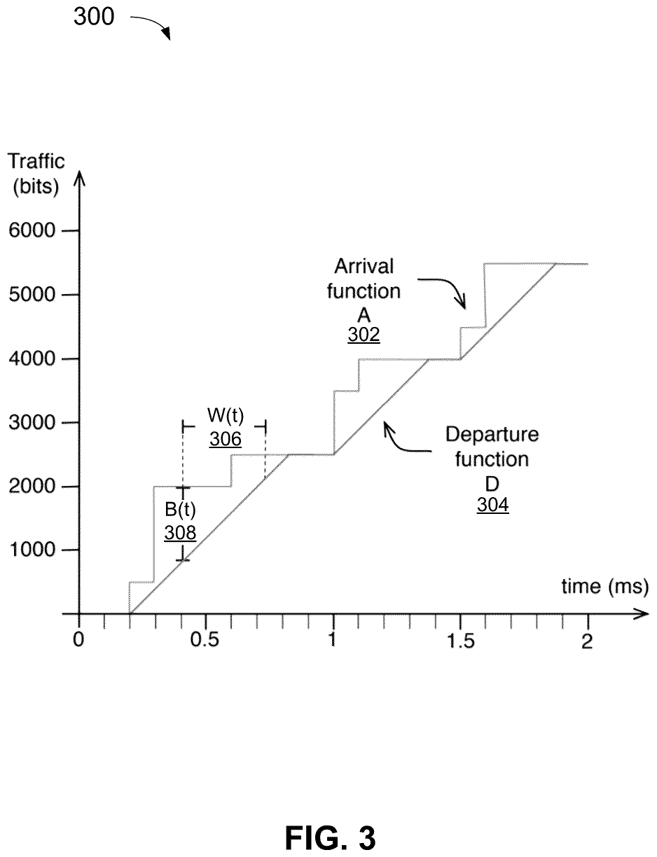

In accordance with some embodiments of this disclosure, an illustrative bit traffic timing diagram is shown in FIG. 3 and described as follows. In some embodiments, arrival function 302 may correspond to arrival function 212, departure function 304 may correspond to departure function 214, delay function 306 may correspond to delay function 216, and backlog function 308 may correspond to backlog function 218. Further, timing diagram 300 may correspond to timing diagram 210. Timing diagram 300 shows how stepwise increments in traffic (e.g., as measured in bits) at the arrival function 302 may cause linear flows of traffic at the departure function 304. Again, comparison of arrival function 302 and departure function 304 may yield delay function 306, which describes the time between when a bit arrives and when a bit departs, and may further yield backlog function 308, which describes the number of bits being buffered to transition from the arrival function 302 to the departure function 304.

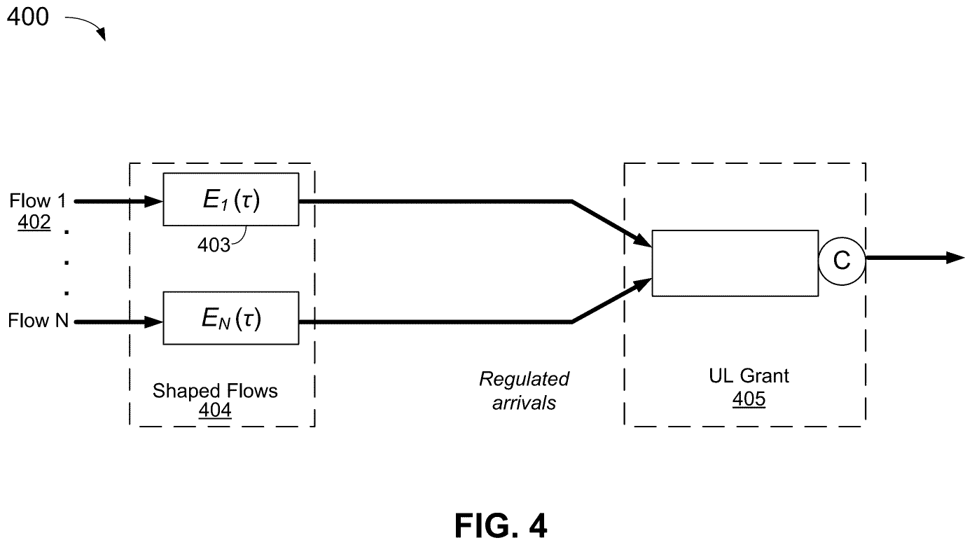

In accordance with some embodiments of this disclosure, envelope shaping of data traffic is shown in FIG. 4 and described as follows. Each data flow, such as flow 1 402, may compete for resources on a given uplink grant and may be shaped by an envelope “E”, such as envelope 1 403, which is denoted according to the function E₁(τ). Respective envelopes E₁-E_{N}, where N is any suitable integer, generate shaped flows 404 of data. The shaped flows 404 cause there to be regulated arrivals of data at UL grant 405. Upon being processed by an envelope, the data may be transmitted as E(t−s)>=A(s,t), as shown in FIG. 4. In some embodiments, a traffic shaper (e.g., envelope 1 403) is a scheduling implementation which enforces that departing UL traffic complies with a given traffic envelope based at least in part on buffering non-compliant traffic. In FIG. 4, there may be N data flows competing for UL resources on a single UL grant 405 of size C, where C may be any suitably sized data allocation.

When processing network traffic, some illustrative and non-limiting reasons to shape traffic for a given data flow include that an operator may want to enforce that traffic from and to a given data flow complies to the subscribed data rate, or that video streaming over a cellular network may require matching the rate of video streams to the available capacity of an RF link.

Such processing (e.g., regulation) of network traffic may be referred to as traffic shaping or as traffic smoothing. Accordingly, transmitted traffic may be classified as shaped/compliant traffic, including traffic that satisfies a given traffic specification (e.g. traffic served in with the bounds of the traffic departure envelope), or non-shaped traffic, including traffic allocated to a grant and exceeding the traffic shaper (e.g., when modeled using a leaky-bucket algorithm, the traffic may cause the water level to exceed traffic shaping bucket). Non-shaped traffic may be considered as lower priority or best-effort priority, and may be buffered if it is not instantly transmitted.

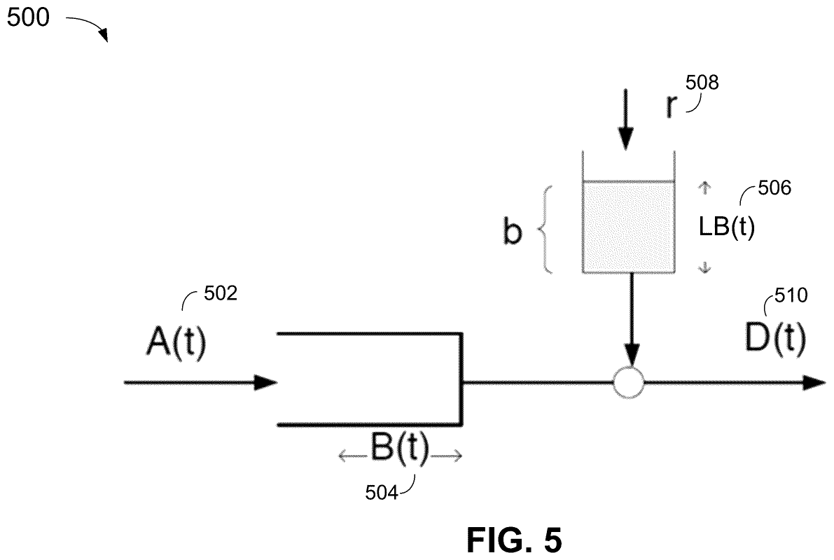

In accordance with some embodiments of this disclosure, an illustrative traffic shaping regulator is shown in FIG. 5 and described as follows. The illustrative regulator of FIG. 5 implements the leaky bucket algorithm, as shown, to regulate traffic. The bucket is filled with fluid (e.g., where the fluid corresponds to an amount of data that is trafficked) up to the indicated level (e.g., where the level indicates a resource allocation), where LB(t) indicates the filling level of the bucket at time t. Function A(t) 502 may correspond to arrival function 212, function B(t) 504 may correspond to backlog function 218, and function D(t) 510 may correspond to departure function 214. The leaky bucket, which is depicted and described by function LB(t) 506, enforces an envelope of the form E(t)=b+rt, where b is the maximum burst size (e.g., which helps to characterize bursty traffic), and r 508 is the long-term traffic rate (e.g., which may be set as the statistical average of the traffic transmission rate requirement). Initially, the bucket is set to LB(0)=b, which is referred to as a full bucket. The bucket is filled with fluid at a rate r 508 (e.g., and the data represented by the fluid is buffered at B(t) 504), however, nothing is added when the bucket is full. The content of the bucket LB(t) corresponds to the maximum amount of traffic that may be transmitted at the time of TB construction (which may be based on the assumption that sufficient space is available for this construction). For each transmission of a SDU, the content of the leaky bucket is reduced by the size of the SDU. When LB(t)=0, the bucket is empty, and no traffic may be transmitted. Traffic arrivals to an empty bucket are stored in the buffer and traffic in the buffer is transmitted at the filling rate r 508.

The LCP algorithm, which is used for UL TB construction in LTE and NR is an example of a leaky bucket implementation. The LCP “Bj” refers to a leaky bucket that enforces traffic to comply to a long-term rate (given by Prioritized Bit Rate (PBR)) and a bucket size (given by Bucket Size Duration (BSD), such that the total long-term rate equals PBR*BSD). The LCP leaky bucket enforces an envelope of the form: E(s)=b+PBR*s; where b is 0 and PBR is the long-term traffic rate (e.g. set as the statistical average of the traffic transmission rate requirement). The LCP bucket thus enforces an envelope of the form: E(s)=PBR*s.

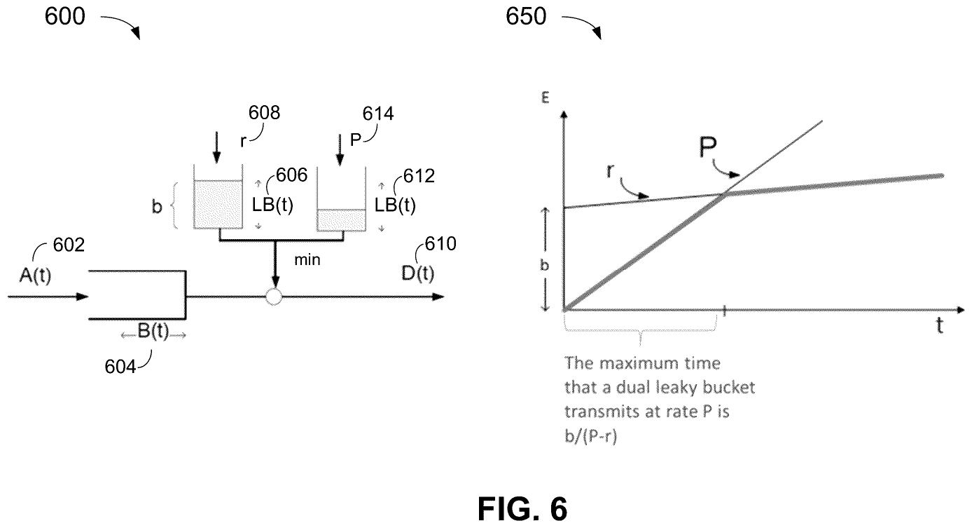

In accordance with some embodiments of this disclosure, an illustrative constrained traffic shaping regulator is shown in FIG. 6 and described as follows. The constrained traffic shaping regulator, which may be referred to as the dual leaky bucket or the peak-rate constrained leaky bucket, is a variation of the typical leaky bucket. For example, elements 602, 604, 606, and 608 of FIG. 6 may respectively correspond to elements 502, 504, 506, and 508 of FIG. 5. However, in contrast to D(t) 510, D(t) 610 is also based on the additional leaky bucket expression LB(t) 612, where this additional leaky bucket is filled by P 614. In particular, the constrained traffic shaping regulator enforces an envelope of the form E(t)=min {Pt; b+rt}, as shown in FIG. 6. The minimum value selected from the two buckets of FIG. 6 passes through to D(t) 610. A dual leaky bucket provides the ability to regulate the traffic rate on a short term (via parameters P 614 and b) and the long term (via parameter r 608), providing flexibility to handle complex arrival functions (e.g., complex formulations of A(t) 602). Traffic rate r 608 may be configured as an average rate of the traffic arrival process, such as the long-term average traffic rate. When the peak rate P 614 is greater than r 608, it represents the maximum data rate of the dual leaky bucket system. The peak rate parameter P 614 bounds the maximum short term transmission rate at which traffic departs the traffic regulator. Timing diagram 650 shows how traffic rate r 608 and peak rate P 614 evolve over time. When P 614 is less than r 608, as shown by the bold line segment 652, traffic is enforced at rate P 614; however, when P 614 is greater than 4 608, as shown by the bold line segment 654, traffic is enforced at rate r 608. In some embodiments, the dual leaky bucket for UL traffic shaping may be implemented in a cellular network.

In some embodiments, the selection of peak rate P 614 may be determined by either: (a) a function of the network resources, e.g., when network resources impose constraints on the maximum rate at which traffic may be processed or transmitted, such as a maximum data burst volume (MDBV) within a period; or (b) a function of the data traffic, e.g., for a transmission of compressed/coded video data traffic. To further define the video data traffic transmission example, a video encoder may require that a video frame must be fully transmitted before the arrival of next frame from the application; and the rate P 614 may be given by the ratio of the largest video frame (in bytes) multiplied by the frame rate (e.g., 50 frames per second). In another example, a gated transmissions may be defined where if a certain PDU (e.g., PDU “x”) within a PDU set succeeds, then a traffic shaper may proceed to transmit further PDUs of the set (e.g., the PDUs with indices greater than x); however, if transmission PDU x does not succeed, then a traffic shaper may halt (e.g., by putting in a buffer) additional PDU transmissions. In such a case of halting additional transmissions, rate P 614 should satisfy the transmission of PDU x in a subsequent grant.

With respect to current communication standards (e.g., as per 3G and 4G protocols), there may be an opportunity to improve TB construction efficiency and there may be a need for a Layer two (L2) data plane interface in accordance with the present disclosure. A typical user plane interface was designed to meet best effort data traffic according to a minimum flow rate and guaranteed bit rate requirements, without having many additional capabilities. Compared to a typical L2 data plane, an L2 data plane interface in accordance with the present disclosure may realize any one or more of the following features.

An L2 data plane in the accordance with the present disclosure may improve computational efficiency. L2 processing scales linearly with packet rate. Thus, as the packet rate increases, it may significantly boost processing demands and power consumption, creating overhead challenges for both the network and the WTRU (e.g., WTRU 102). Layering of L2 protocols, as may occur in traditional architectures, creates an overly hierarchical structure that may create latencies and increase computational complexity.

An L2 data plane in the accordance with the present disclosure may improve QoS, latency, reliability, or any combination thereof. An L2 interface in accordance with the present disclosure may support a variable QoS requirement, low latency, and high reliability, including when working with extreme applications, such as extended reality (XR), virtual reality (VR), augmented reality (AR), High Reliability Low Latency Communication (HRLLC), or enhanced Ultra Reliable Low Latency Communication (eURLLC). Retransmissions currently are duplicated in multiple layers. Retransmissions at higher layers (e.g. Radio Link Control (RLC)) are too slow to meet latency sensitive applications (e.g., as are found in XR applications). Retransmissions may also be quite rigid (e.g., requiring that retx data is exactly the same, TB size across transmissions is consistent, a single carrier is used, or other inflexible requirements). QoS attributes may be assigned to each data set/channel, including the dual Key Performance Indicators (KPIs): Priority, PBR, Packet Delay Budget (PDB), Packet Error Rate (PER), Block Error Rate (BLER), and additional KPIs: PDU Set Delay Budget (PSDB), dependencies to other sets, strict delay, energy consumption, complexity metrics. An L2 interface in accordance with the present disclosure may provide elastic Quality of Experience (QoE) level varying (e.g., with QoE being between the minimum data rate, or GBR, and the maximum data rate), while satisfying QoS requirements. Moreover, the QoE may be configured to meet a certain minimum requirement. For example, the WTRU may start transmission of data with a given QoE level that is higher, then as WTRU moves out of coverage, experiences cell congestion, or when data rate drops, the WTRU may then reduce the QoE level or reduce the number of data packet sets that are transmitted (e.g., if there are multiple/multi-modal streams, the WTRU may drop one stream that is not necessary to meet the min QoE level while still maintaining the QoS).

An L2 data plane in the accordance with the present disclosure may support different data types. In some typical L2 data planes, SRB and DRB data are differentiated, and treatment of UP data QoS is controlled by QoS flow to DRB mapping. After having been mapped to a DRB, data packet treatment is done semi-statically. However, new system applications (e.g. AI/ML, XR, sensing, volumetric video, any other new application, or any combination thereof) introduce new data types, which may potentially be provided within a QoS flow. NR UL does not provide differentiated treatment for more important/systematic packets (e.g. for a QoS flow). Even so, data sets may be classified by type (e.g. control, data, sensory, AI/ML data). The L2 interface may therefore be configured to avoid unnecessary data transmission and to handle QoS/QoE dependencies between different data types (UP, CP, system data), including dependencies between data packets of the same type.

An L2 data plane in the accordance with the present disclosure may improve WTRU and/or network power consumption efficiency. The L2 protocol should enable both WTRU and network (NW) power savings. Data Radio Bearers (DRBs) are not elastic in terms of resource allocation and mapping across cells and cell groups. The L2 interface may therefore support means for timely WTRU reachability and WTRU processing chain power consumption, thereby balancing NW & WTRU energy consumption. A PDU should be able to be transmitted and/or received in a dynamic manner, without rigid restrictions on DRB, carrier, cell group, any other network entity, or any combination thereof.

An L2 plane in the accordance with the present disclosure may improve the network's ability for data scheduling, including handling various levels of data capacity and handling data congestion. Configured grants may be responsive to delay bounds but may consume heavy overhead. Transmission on dynamic grants following Scheduling Request (SR)/Buffer Status Report (BSR) may incur delays. LCP may be based on leaky bucket uplink traffic shaping, and may not consider inter-packet associations, latency bounds, or congestion.

An L2 plane in the accordance with the present disclosure may provide application layer awareness. NR UP does not provide prioritized treatment for high-priority data packets (where the relevance of the priority may vary over time or over other control reception, e.g. within a bearer). However, various applications generate data packets of varying importance. L2 protocols have not evolved with new application layer transport protocols (e.g., Quick User Datagram Protocol (UDP) Internet Connections (QUIC) may be developed for faster, more reliable, and more efficient data transfer). As used herein, awareness includes a RAN being aware of application QoS and QoE metrics/data (e.g., events, important/relevant data) and the application being aware of RAN dynamic conditions (e.g. radio conditions, congestion, cell load, any other RAN condition, kor any combination thereof). An application itself may adjust the rate of the packet set, and in such case the WTRU should not exhibit a different underlying QoE level (e.g. when the video rate is decreased by the application). This capability may be provided whether or not the WTRU is aware of the application layer (e.g., there may be a first case for a WTRU with no awareness, and a second case for a WTRU with some type of awareness). Awareness may also involve awareness of application flow dependencies and synchronization and other system data (e.g. sensory, ML, CP triggered events such as network handover, any other suitable data, or any combination thereof).

In accordance with some embodiments of this disclosure, methods and systems for reducing unnecessary segmentation in LCP are provided as follows.

In certain representative embodiments, a WTRU (e.g., WTRU 102) allocates UL resources within an UL grant only if the shaping bucket level is greater than or equal to the SDU size. The WTRU may multiplex a padding BSR to indicate other data buffered and/or a need for another grant later.

In certain representative embodiments, a packet is transmitted only if Bj is greater than or equal to the packet size, in which case the contents of the bucket are reduced by the packet size. An SDU may be transmitted as a whole or not at all.

In certain representative embodiments, a packet at the head of the buffer may be transmitted only when the filling level of the bucket is greater than or equal to the size of the packet.

In certain representative embodiments, there may be a process of elimination of LCHs. For example, the WTRU may first start with x LCHs with buffered data, but none of them may be transmitted without segmentation. Then, the WTRU may eliminate one LCH based on one criterion (e.g., the LCH with least water level “Bj”, the LCH with largest gap between SDU size and water level, the LCH of least priority, the LCH with most remaining time with its data). Then, the WTRU may allocate Bj bits of the eliminated LCH to the buckets of remaining LCHs (x-1). The WTRU may repeat these steps until LCH(s) may be allocated without segmentation.

In certain representative embodiments, the methods and systems disclosed herein for reducing unnecessary segmentation in LCP may be applied to gated transmissions and/or systematic video frames that need to be transmitted fully before transmission of other frames.

In certain representative embodiments, a WTRU may include a special BSR to indicate whether a particular flow was skipped even though it has buffered data. The particular flow may be allocated with higher priority than other data or may be included opportunistically in case there are padding bits left after the LCP.

In accordance with some embodiments of this disclosure, methods and systems for selective segmentation are provided as follows.

In certain representative embodiments, a WTRU (e.g., WTRU 102) may segment an SDU only if a condition is met (e.g., a selective segmentation condition, a set of selective segmentation conditions). The WTRU may delay transmission of some MAC CEs if they cause segmentation.

In certain representative embodiments, if a first condition (or first set of conditions) is met, the WTRU may deliver a whole SDU to lower layers (e.g., MAC) for TB construction and/or data multiplexing for transmission. If the first condition (or first set of conditions) is not met, the WTRU may keep the SDU in the buffer (e.g., a data flow buffer) or deliver a segment of the SDU.

In certain representative embodiments, if a second condition (or second set of conditions) is met, the WTRU may deliver a segment of the SDU to lower layers at the WTRU for transmission and/or data multiplexing. As used herein, descriptions of a SDU evaluation is not limited to pure SDU level evaluation, but rather, the same conditions may apply in an evaluation of a remaining segment of an SDU.

In certain representative embodiments, each of the first condition, which may be a first set of conditions, and the second condition, which may be a second set of conditions, may comprise any combination of the following selective segmentation conditions.

A selective segmentation condition may be that a remaining time associated with the SDU is less than or greater than a configured threshold. The remaining time may be determined by the WTRU as the time until the PDB or PSDB of the flow or of the SDU is exhausted. The remaining time may be the time until the discard timer associated with the packet expires. The discard timer may be maintained at higher layers, e.g. Packet Data Convergence Protocol (PDCP), or by the segmentation/multiplexing layer itself (e.g., MAC).

A selective segmentation condition may be any QoS classification condition or any combination thereof.

A selective segmentation condition may be that the SDU is from a subset of data flow(s) where the data flows are configured.

A selective segmentation condition may be that the SDU does not require segmentation at higher layers (e.g. above MAC layer). The WTRU may determine that a SDU is subject to segmentation based on the data type, data flow, whether the SDU fits within a given resource allocation, whether the SDU size is greater than a threshold number of bits, or any combination thereof.

A selective segmentation condition may be that the SDU size is larger than the TBS of the grant. A selective segmentation condition may be that the SDU size is larger than the remaining number of bits that have not been allocated in the uplink grant. A selective segmentation condition may be that the remaining number of bits that have not been allocated in the uplink grant is larger than a threshold number of bits.

A selective segmentation condition may be that the SDU is a data SDU, a control SDU, contains system information, contains a control SDU for a higher layer, is of a data collection type (e.g., for machine learning and/or training), of a sensory data type, or any combination thereof.

A selective segmentation condition may be that the SDU belongs to a flow that is configured (or not configured) for segmentation.

A selective segmentation condition may be that a further uplink grant is available to the WTRU upon processing the given uplink grant. The further uplink grant may also need to satisfy a condition to be regarded as a further uplink grant (e.g., is available within a time limit, has grant size greater than a threshold, is permitted (e.g., by LCH restrictions) to multiplex the data of the SD).

In certain representative embodiments, a WTRU may allocate UL resources of an available grand (e.g., in LCP) to a MAC CE if a third condition, which may be a third set of conditions, is met. The third condition, which may be a third set of conditions, may comprise any combination of the following MAC CE inclusion conditions

A MAC CE inclusion condition may be that the MAC CE is of a certain type (e.g., Power Headroom Report (PHR), BSR, Beam Failure Recover (BFR), Dynamic Source Routing (DSR)).

A MAC CE inclusion condition may be that the MAC CE is of a certain priority (e.g., a priority above or below a configured threshold). The priority of a MAC CE may be determined from a predefined prioritization list (which may prioritize data and other control elements) or may be configured. The configured threshold may be determined based on the priority of data in the LCP procedure.

A MAC CE inclusion condition may be that the MAC CE is configured or predefined to be included regardless of segmentation implications.

A MAC CE inclusion condition may be that an additional SDU is not segmented by the inclusion of the MAC CE. For example, for a MAC CE that is potentially assigned resources on an uplink grant after other data (e.g., other system, control, or user plane data), the WTRU may include the MAC CE only if the inclusion does not cause the segmentation of another SDU that would have been (or already has been) allocated to the grant. The additional SDU may be conditioned to be of a certain data/control flow, a data type, one that meets any of the segmentation conditions, or any combination thereof.

In accordance with some embodiments of this disclosure, definitions and terminology are provided as follows.

A gated traffic data flow (or periodic data flow) may be defined as a data set, where there may be a subset of gating PDUs and non-gated PDUs. Transmission of a gating PDU enables the transmission of non-gating PDUs.

In certain representative embodiments, if a first PDU arrives at periodic intervals and PDU x is a gating systematic PDU that enables a gated transmission, then a second PDU may not be transmitted if the first PDU is not transmitted or if the first PDU is not deemed to be transmitted successfully (e.g. acknowledged). In some embodiments, if the first PDU arrives at a first time, subsequent PDUs that arrive between the first time and a second time, wherein the second time occurs one periodic interval after the first time, may not be transmitted until the first PDU has been transmitted successfully.

In certain representative embodiments, some video applications are not able to benefit from transmission of frames following a systematic frame, as the picture may not be complete without it. In such embodiments, a systematic frame should be fully transmitted before transmission of subsequent frames.

For such systematic frames, a WTRU (e.g., WTRU 102) may increase the long-term traffic rate (r) and/or reinitialize the bucket with a maximum burst size (b) value to meet scheduling of the PDU (e.g., select a set of parameters associated with a higher QoE transmission).

In certain representative embodiments, for other PDUs, a lower value for b and/or r may be used.

As used herein, channel conditions may refer to any conditions relating to the state of a radio and/or channel, which may be determined by the WTRU based on a WTRU measurement (e.g., L1, Signal-to-Interference-plus-Noise Ratio (SINR), Reference Signal Received Power (RSRP), Channel Quality Indicator (CQI), Modulation and Coding Scheme (MCS), channel occupancy, Received Signal Strength Indicator (RSSI), power headroom, exposure headroom, or any combination thereof), L3/mobility-based measurements (e.g. RSRP, Reference Signal Received Quality (RSRQ), s-measure), an Radio Link Monitoring (RLM) state, channel availability in unlicensed spectrum (e.g., whether the channel is occupied based on determination of an Listen Before Talk (LBT) procedure or whether the channel is deemed to have experienced a consistent LBT failure), or any combination thereof.

As used herein, Uplink Control Information (UCI) may include Channel State Information (CSI), Hybrid Automatic Repeat Request (HARQ) feedback for one or more HARQ processes, SR, Link recovery request (LRR), Configured Grant Uplink Control Information (CG-UCI), other control information bits that may be transmitted on the Physical Uplink Control Chanel (PUCCH) or Physical Uplink Shared Channel (PUSCH), or any combination thereof.

A property of scheduling information (e.g., an uplink grant or a downlink assignment) may consist of at least one of the following: a frequency allocation; An aspect of time allocation, such as time instance and/or a time duration; A priority; A modulation and coding scheme; A TBS; A number of spatial layers; A number of transport blocks to be carried; A Transmission Configuration Indicator (TCI) state or Send Routing Information (SRI); A number of repetitions; Whether the grant is a configured grant type 1 (i.e., WTRU immediately using the configured UL resources after receiving the configuration information), type 2 (i.e., WTRU waiting until an explicit MAC CE indication before using the configured UL resources) or a dynamic grant.

An indication by Data Center Interconnect (DCI), or an indication, may consist of at least one of the following: An explicit indication by a DCI field or by a Radio Network Temporary Identifier (RNTI) used to mask Cyclic Redundancy Check (CRC) of the Physical Downlink Control Channel (PDCCH); An implicit indication by a property such as DCI format, DCI size, Coreset or search space, aggregation level, identity of first control channel resource (e.g., index of first Controlled Customer Equipment (CCE)) for a DCI, where the mapping between the property and the value may be signaled by Radio Resource Control (RRC) or MAC; An explicit indication by a Downlink (DL) MAC CE.

As used herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’. A symbol ‘/’ (e.g., forward slash) may be used herein to represent ‘and/or’, where for example, ‘A/B’ may imply ‘A and/or B’.

As used herein, an LCH and data flows may be used interchangeably. It should be noted that while the description herein defines a SDU as unit to evaluate, the description is not limited to pure SDU level evaluation, but rather, the same conditions may apply in evaluation of a remaining segment of an SDU. Herein, an SDU may refer to a data unit or a packet, which may include SDU or a segment of a SDU.

In accordance with some embodiments of this disclosure, a definition of a UL traffic shaping policy is provided as follows.

A traffic shaper may be a scheduling implementation which enforces that departing UL traffic complies to a given traffic envelope and which may buffer non-compliant traffic. Examples of a traffic shaper are provided as follows.

In some embodiments, a traffic shaper may be a leaky bucket or a dual leaky bucket. The traffic shaper may comprise shaping exceptions when some conditions are met. The traffic shaper may comprise multiple shapers where one or more is applicable for a given time/grant. When more than one shaper is applicable, the minimum shaping water level (i.e., Bj) among the shapers is taken as the overall limit.

In some embodiments, a traffic shaper may be a maximum burst size shaper (e.g., E=burst size).

In some embodiments, a traffic shaper may be deterministic shapers for periodic traffic (e.g., E=A(period)/period), wherein A(period) represents function “A” with dependent variable “period”.

In some embodiments, a traffic shaper may be time variant shapers enabled by NW signaling to control shaping parameters, for example, a leaky bucket with dynamically signaled shaping parameters (e.g., r, b, P, BSD).

In some embodiments, a traffic shaper may be shortest remaining time first, among buffered data units applicable for the grant.

In some embodiments, a traffic shaper may be highest static priority first (e.g., highest QoS class), among buffered data units applicable for the grant.

In some embodiments, a traffic shaper may be first in first out, among buffered data units applicable for the grant.

In some embodiments, a traffic shaper may be no shaping (e.g., a data flow is not limited, a data flow is limited only to the size of the grant).

In certain representative embodiments, the WTRU (e.g., WTRU 102) may maintain a UL traffic shaping bucket (e.g., Bj) for each data flow, each QoS class, each UL traffic shaping envelope, or any combination thereof. When serving buffered data from a given flow and allocating UL resources in the grant to it (e.g., bit allocation in the TB), the WTRU may decrease the bucket by the value of the served buffered bits. The water level in the bucket (e.g., Bj) may be negative at some time, possibly for some exceptions (e.g., when using a non-default envelope, when serving data from data units from a given QoS class). For a given grant, the WTRU may serve buffered data to the grant from each flow up to the water shaping level (e.g., Bj), at least in a first allocation step/round. In a second round(s), the WTRU may allocate remaining resources in the grant according the same or a different envelope or without shaping at all. The water level (e.g., Bj) may be decreased in the first and/or the second round(s) of resource allocation.

For a given data flow for which the WTRU maintains a shaping bucket, if the WTRU changes the shaping envelope for a subset of data units, the WTRU may update the bucket as follows. The water level (e.g., Bj) may equal Bj plus the fill rate of the applicable envelope, r, multiplied by a time since the bucket was last updated. The WTRU may fill the bucket with the maximum burst size, b, of the applicable envelope. The WTRU may assume an updated bucket size of (BSD times r) while the applicable envelope is used for a given data unit.

If the WTRU autonomously changes any shaping parameters/envelope, the WTRU may notify the serving cell (e.g., part of assistance info or a MAC CE).

In accordance with some embodiments of this disclosure, methods and systems for RAN data plane architecture are provided as follows.

In some embodiments, a data plane architecture framework (e.g., the data plane architecture framework illustrated in FIG. 6), an application may provide one or more IP flows for transmission over a medium. Each IP flow may then go through a transport layer protocol (e.g., TCP/IP, QUIC, Real-time Protocol (RTP), Mobile-Origination Call (MOC)). Each IP flow (e.g., a PDU session) may go through a Radio Access Network (RAN) (e.g., RAN 104/113) core network (e.g., core network 105/115), which may map it to a RAN data flow or a RAN data set. For each RAN data flow, the core network may attach some QoS requirements, a QoS metric, a range of QoE metrics, or any combination thereof.

As used herein, a RAN data flow may represent a logical association between data packets and/or units (e.g., originating from the same IP flow). Such association may be based on such data units being associated to the same IP flow, application flow, having the same association packet marked either by the core network or the application, or any combination thereof.

Some RAN data flows may not originate from a user application, but rather from control plane (e.g., control data and RAN signaling and configurations), an intelligence plane (e.g., data collected from AI/ML services), a computing plan (e.g., used for native computing for computing services), a system plane (i.e., data originating within the RAN, e.g. due to sensing or positioning services), a security plane, or any combination thereof.

The WTRU (e.g., WTRU 102) may assign a QoS class to each data unit within a RAN data flow for the purpose of characterization of how data should be transmitted. A data protocol plane may contain a data unit classification function for QoS/QoE marking throughout the protocol chain. The QoS/QoE class may be determined in such layer according to one or more configured or predefined rule. Such QoS class may be used in various layers within the data plan protocol chain for achieving a certain QoS requirement or a QoE level. A QoS class may indicate part of a protocol layer header. Each QoS class may be associated with a QoS treatment profile in the RAN, which may be configured semi-statically. Each QoS treatment profile may contain a number of parameters to control the RAN treatment of the data transmission/reception and a number of metrics to achieve the QoE level for a given layer in the protocol chain. Each QoS class or QoS treatment profile may be associated and/or configured with a priority index, an importance level, a delay bound, a reliability level, a guaranteed bit rate, a maximum bit rate, a maximum packet loss rate, or any combination thereof.

In accordance with some embodiments of this disclosure, methods and systems for classification of packets with a data flow and their conditions and rules as provided as follows.

The WTRU (e.g., WTRU 102) may use a procedure to classify UL data units (e.g., packets within a data flow, SDUs, PDUs within a PDU set) on a dynamic basis, wherein a data unit may be assigned with a QoS Class if it meets one or more conditions.

When a condition for QoS classification is met, the WTRU may assign a certain QoS class value to a given data unit, which may or may not be the default QoS class. The WTRU may be configured with a default QoS class, which may be preconfigured semi-statically for the whole data flow. If no special classification conditions are met, the WTRU may classify a data unit from such flow with the configured default QoS class for the data flow. The WTRU may be configured or predefined with one or more non-default QoS class(es), wherein there may be a mapping between a given QoS class and a QoS classification condition or any combination thereof; once met, the WTRU may associate the data unit with the non-default QoS class.

A QoS classification condition may be based on packet priority. Packet priority may be based on the possibility of transmission/inclusion of buffered data from a subset of PDUs within a PDU set, wherein such PDUs may be configured or predetermined to be of higher priority, a lower delay bound, high QoS treatment profile compared to other PDUs within the set, or any combination thereof. If the data unit is of higher priority, the WTRU may associate the data unit with a given QoS class. If the data unit is of lower priority, the WTRU may associate the data unit with another QoS class.

A QoS classification condition may be based on packet importance. Packet importance may be based on the possibility of transmission/inclusion of buffered data from a subset of PDUs within a PDU set, wherein such PDUs may be configured or predetermined to be of higher importance compared to other PDUs within the set, wherein importance may be a value obtained from an indication from the core network packet profile, the application interface, or from the service characteristics (e.g., the period of the packet or the type of packet associated with it). If the data unit is of higher importance, the WTRU may associate data unit with a given QoS class. If the data unit is of lower importance, the WTRU may associate data unit with another QoS class.

A QoS classification condition may be based on a packet delay budget. A packet delay budget may be based on a possibility of transmission/inclusion of buffered data from a subset of PDUs within a PDU set, wherein the remaining time until the delay budget for the PDU or the underlying application may be less than a threshold. If the delay budget is less than a threshold, the WTRU may associate data unit with a given QoS class.

A QoS classification condition may be based on data data type. The data type may be met as a function of inclusion of data from a given type, e.g. AI/ML, XR, sensing, volumetric video, or any combination thereof. For example, for a data unit containing AL/ML data, the WTRU may associate data unit with a given QoS class. For a data unit containing sensing data, the WTRU may associate data unit with another QoS class.

A QoS classification condition may be a reception of an indication from the application or the RAN-application interface (API): the application may indicate that for a given data unit, a differentiated QoS class is to be associated. The Indication may provide a given QoS class or an identifier associated with it. The WTRU may be configured with a given non-default QoS class to apply to a data unit once an indication/flag is received from the API for such data unit. For example, upon reception of an indication from higher layers (e.g., from application) indicating that such packet needs to be prioritized ahead of other buffered packets in the queue for such data flow, the WTRU may associate a different (e.g., non-default) QoS class to the data unit.

A QoS classification condition may be a reception of an indication from the network overriding the configured default QoS class for one or more data flows. The Indication may include a given QoS class to apply, possibly for a period of time. Such indication may be determined as a function of a property of the scheduling information (e.g., in the DCI) or an indication by the DCI.

A QoS classification condition may be reception of an indication for a given grant: a DCI may signal a given QoS class, for such QoS class, only data associated with such class can be multiplexed. Alternatively, the WTRU may multiplex data regularly on the grant then treat the whole TB as data with the signaled QoS class (e.g., in lower layers). Such indication may be determined as a function of a property of the scheduling information (e.g., in the DCI) or an indication by the DCI.

A QoS classification condition may be based on data from a gating data set. For example, the WTRU may associate a given non-default QoS class to a gating data unit.

A QoS classification condition may be a function of dependent data or data set. For example, for a data unit that other units depend on (e.g., a Forward Error Correction (FEC) source packet, a video defining frame (e.g., an I frame), a gating data unit), a non-default (e.g., prioritized) QoS class may be assigned. For dependent, duplicated, or redundant data units, a different QoS class may be assigned (e.g., a default QoS class associated with the flow)

A QoS classification condition may be a function of systematic PDU within a set. For example, a QoS classification condition may be based on a possibility of transmission/inclusion of buffered data of a systematic frame/data unit within a data flow (e.g., source data units that are encoded, systematic video frames).

A QoS classification condition may be based on satisfying one or more control plane event. For example, a QoS classification condition may be based on satisfying one or more mobility event condition, satisfying a conditional handover condition to one or more handover candidate. For example, upon satisfying a mobility, a RLM, a beam failure, or a Radio Link Failure (RLF) condition, the WTRU may associate a different QoS class with a data unit, possibly for a period of time associated with the CP event.

A QoS classification condition may be based on sensing an object or determining an outcome from a sensing or positioning procedure. For example, sending data may be configured or pre-associated with a given QoS class. Upon detection of an object as a function of sensing or a spatial computing service as a outcome of sensing, the WTRU may select a certain QoS class (e.g., a non-default or configured QoS class).

A QoS classification condition may be based on dropping or adding one or more data flows. For example, upon adding or dropping one or more service or a data flows (e.g., from a multi-modal service or session), the WTRU may change the QoS class associated with the remaining data flow or dependent data flow.

A QoS classification condition may be based on synchronization between data flows. For example, if synchronization between data flows is configured or indicated from the application or the core network, the WTRU may associated one QoS class when for data units when a dependent data flow is synchronized and another QoS class when the data flow is not synchronized or within a period of miss-synchronization (e.g., a remaining synch time is greater than or less than a threshold). If a common identifier is used (e.g., signaled from the application or the core network) to associated two flows, the WTRU may use the same QoS class for data units of both data flows. Once dissociated, the WTRU may revert to the default QoS classes configure for each data flow individually.

A QoS classification condition may be based on dropping or adding one or more dependent data types. For example, if the WTRU is configured to need X out of Y data units to decode an overall packet (e.g., an FEC encoded packet, a source video frame), the WTRU may select a given QoS class when X out of Y have been successfully decoded, while the WTRU may associate a different QoS class when X out of Y have not been successfully decoded and/or if X′ out of Y units have been received, and/or if X″ units have been not acknowledged but have been received.

A QoS classification condition may be based on satisfying one or more event from the transport layer protocol (e.g., generating TCP Acknowledgement (ACK), transmission of an out of order packet within a transport protocol session/connection, reading a specific value from the header of the transport layer protocol for a given packet). Once such condition is met, the WTRU may associate the associated data unit of the related RAN (e.g., RAN 104/113) data flow with a given QoS class. The WTRU may be able to determine or more property of the transport layer protocol from a relay on top of the RAN protocol stack, which may be used to decipher and/or decrypt the transport layer header and/or content if encrypted.

A QoS classification condition may be based on measuring a channel condition and determining whether the measurement it less than or greater than a given threshold. A QoS classification condition may be based on measuring a change in the channel conditions and determining whether the measurement is less than or greater than a given threshold. Once such condition is met, the WTRU may associate a data unit with a given QoS class.

A QoS classification condition may be dependent on whether the data unit is transmitted initially or retransmitted. A QoS classification condition may be dependent on a retransmission number.

A QoS classification condition may be a function of the energy saving state of the network (which may be indicated to the WTRU) or the power saving state of the WTRU (e.g., whether DRX is used).

In some embodiments, a condition may be bound for a period of time, e.g. once satisfied, it is considered satisfied until the period of time, which may be configured or predetermined, has elapsed. While the condition is met during the period of time, a differentiated QoS class may apply to the data unit. Once the period expires, the data unit may be associated with a default QoS class or a reverted QoS class that was assigned before the condition was met. A condition may be bound to a subset of data flows (e.g., a QoS flow, data unit set, a DRB, LCH, Logical Channel Group (LCG), PDU set). Once satisfied, the WTRU may determine that it is applied only for the applicable set of data flows (which may be configured by higher layer signalling) and the associated QoS class may be applied for the data unit. A condition may be bound to a subset data types (e.g., control, user data, system data, intelligence data (AI/ML), positioning data, sensing data). Once satisfied, the WTRU may determine that it is applied only for the applicable set of data type (which may be configured by higher layer signalling) and the associated QoS class is applied for the data unit. A condition may be bound to a subset of device capability. A condition may be bound to a subset of uplink grants, grant types (e.g., dynamic vs. semi-static/configured grants), a subset of grant indication properties, a property of the grant scheduling indication (e.g., the DCI indication or as a function of the DCI scheduling parameters), or any combination thereof.

In accordance with some embodiments of this disclosure, methods and systems for segmentation reduction in leaky bucket and/or traffic shaping are provided as follows.

In some embodiments, a WTRU (e.g., WTRU 102) may allocate UL resources within an UL grant only if the shaping bucket level is greater than or equal to the SDU size. The WTRU may multiplex a padding BSR to indicate other data buffered or a need for another grant at a later time.

In a transport block construction algorithm that considers a multitude of data flows with buffered data that can be allocated to an available grant (e.g., a logical channel prioritization algorithm, herein referred to as LCP), the WTRU may determine whether to include an SDU from a data flow on a per grant basis and/or on a per SDU basis.

For packet (e.g., an SDU from higher layers above MAC), the WTRU may allocate a packet of size L bits (including upper layer headers) to a grant only if one or more of the following conditions is met (herein referred to as inclusion conditions):

An inclusion condition may be that the bucket level for the data flow (e.g., LCH) associated with the data is greater than L bits, wherein the bucket level may act as a traffic shaper for the data flow. L bits may be the size of the SDU in question for inclusion in the grant.

An inclusion condition may be that the number of bits served to the data flow in the past x milliseconds is not larger than Y bits, wherein x and Y are configured. Y may be equal to the size of the SDU (e.g., L bits)

An inclusion condition may be that the SDU is at the head of line of the data buffer associated with the data flow

An inclusion condition may be that the SDU is no more than M SDUs behind the SDU that is at the head of the buffer order, wherein M is configured.

An inclusion condition may be that the time until the PDB associated with the SDU is less than a configured threshold.

An inclusion condition may be that the remaining time associated with the SDU is less than or greater than a configured threshold, wherein the remaining time is determined by the WTRU as the time until the flow's PDB is exhausted or the time until the discard timer associated with the SDU is expired. The discard timer may be maintained at higher layers (e.g., PDCP).

An inclusion condition may be that the remaining number of bits that have not been allocated in the uplink grant is larger than a threshold, wherein the threshold is configured or determined to be the size needed to include one or more MAC CEs that have been triggered (e.g., a padding BSR, a BSR, or any BSR that is included post data allocation to the grant, or any MAC CE that is included by with a lower priority than data).

An inclusion condition may be that the SDU is associated with a certain QoS classification or meets at least one QoS classification condition.

An inclusion condition may be that the SDU is associated with a data flow (e.g., LCH) that is configured with traffic shaping or a traffic shaping policy.

An inclusion condition may be whether the SDU is a gating SDU or is of high importance/priority (e.g., where the priority is above a configured threshold and/or the priority is determined from the LCH's priority).

An inclusion condition may be that a time since SDU arrival at the WTRU buffer is larger than a threshold.

An inclusion condition may be that the bucket level (e.g., LB(t)) is above a threshold, wherein the threshold may be relative to the SDU size.

An inclusion condition may be that the segment size of the SDU is not less than a threshold, possibly relative to the SDU size or other previously transmitted/acknowledged segments of the same SDU.

An inclusion condition may be that the segment size of the SDU is less than a threshold, possibly relative to the SDU size or other previously transmitted/acknowledged segments of the same SDU.

An inclusion condition may be that the inclusion of the SDU results in still having enough space of MAC CEs, potentially only MAC CEs that have an LCP priority higher than the priority of data in the SDU. There may be prioritization over some lower priority MAC CEs if an SDU may be delivered without segmentation, wherein such prioritization may be predefined or configured.

An inclusion condition may be the SDU segment size being the first, last, or a middle segment of an SDU.

An inclusion condition may be that the SDU is a retransmission of a previously transmitted SDU segment (e.g., it is a segment of segment or not)

An inclusion condition may be that the SDU segment is being retransmitted by HARQ and/or the number of HARQ retransmissions being less than a configured threshold.

An inclusion condition may be that the SDU is ahead in the data flow buffer of delay critical SDU in the same queue, wherein delay criticality may be determined based on the remaining time.

An inclusion condition may be based on measured channel conditions being below or above a threshold.

An inclusion condition may be a selective segmentation condition described in section 4.3 or any combination thereof.

If one or more of the inclusion conditions is not met, the WTRU may keep the SDU in the data flow buffer for transmission at a later time or on a different grant. If one or more (e.g., all configured) of the inclusion conditions is met, the WTRU may transmit the SDU in full or a segment of it. The WTRU may make such determination based alternatively on a second set of conditions. In one example, for a packet arrival of size L at time t, the packet is transmitted only if LB(t) is greater than or equal to L, and the contents of the bucket is reduced by L. An SDU may be transmitted as a whole or not at all. In some embodiments, the packet at the head of the buffer may be transmitted only when the filling level of the bucket is greater than or equal to the size of the packet.

In some embodiments, the WTRU may keep re-evaluating inclusion conditions until no SDU may be allocated to the grant. The WTRU may evaluate such conditions by order of data flow priority, order of SDU size, order of data type, order of QoS class, or any combination thereof. In some embodiments, the WTRU may evaluate such conditions only in a subset of steps of the LCP process (e.g., only in the first round of resource allocation in LCP, only in the second round of resource allocation in LCP, a combination of rounds, or any combination therein).

In some embodiments, the WTRU may use a process of elimination of data flow and/or SDUs, wherein SDU may be eliminated if they do not meet one or more of the inclusion conditions. The WTRU may re-evaluate the conditions of an SDU if another SDU is eliminated. For example, the WTRU may first start with 3 SDUs and/or LCHs with buffered data, but none of them can be transmitted without segmentation. Then, the WTRU may eliminate one SDU and/or LCH based on one criterion (e.g., the LCH with least water level “Bj”, the SDU with largest gap between SDU size and water level (LB(t)), the SDU and/or LCH of least priority). Then, the WTRU may allocate LB(t) of the eliminated LCH to the buckets of remaining LCHs. The WTRU may repeat these steps until LCH(s) may be allocated without segmentation.

In some embodiments, the WTRU may have SDUs buffered from a data flow configured with traffic of type “Gated transmissions” or with systematic video frames that need to be transmitted fully before transmission of other frames. For a gating SDU, the WTRU may include the SDU without evaluating one or more of conditions in the inclusion conditions above (e.g., even if it causes segmentation of the SDU). In some embodiments, the WTRU may not segment a gating SDU and keep it in its buffer until the traffic shaper (e.g., the water level in the bucket) allows its transmission fully and/or the time since its arrival is above a threshold.

In some embodiments, the WTRU may include an indication part of the transport block/PDU, in case a buffered SDU is kept in the buffer (e.g., in case one or more of the inclusion conditions are not met), to inform the network that an SDU remains buffered even if there is possible padding in the TB. Such indication may be a padding BSR, an indication in a MAC header, a UCI, a MAC CE that is multiplexed in the same TB or a different TB, or any combination thereof. For example, the WTRU may include a special padding BSR to indicate that a certain flow was skipped even though it has buffered data. Such an indication may be allocated with higher priority than data in the LCP allocation process.

In some embodiments, the WTRU may select physical layer transmission parameters (e.g., TBS, MCS, grant from a multiple grants possibly overlapping, or any combination thereof) as a function of the PDU size determined by MAC and LCP, considering which SDUs are included in full, which SDUs are not, and which SDUs are segmented and included. For example, once MAC determines that the PDU size is y bis, the WTRU Physical Layer (PHY) may select to transmit the y bits using a TBS and/or MSC of x bits, wherein x is the lowest available TBS (e.g., from the selection of possible MCSs and/or grants available) that can meet the transmission of y bits.

In some embodiments, the WTRU may provide an indication (e.g., in a MAC CE/SR/BSR/UCI/DSR) to notify the scheduler to provide a grant for the delay critical data (e.g. reliable MCS) without segmentation. Such notification may be provided on the same grant on which the non-delay critical SDU (e.g., the one ahead of the delay critical one in the data queue) is transmitted or on a different grant/PDU. The WTRU may allocate enough space for such indication (e.g., in the LCP algorithm) ahead of other data, wherein the data may be of the same priority or of lower priority than that of the delay critical SDU.

In accordance with some embodiments of this disclosure, systems and methods for selective segmentation are provided as follows.

In some embodiments, the WTRU may segment an SDU only if a condition is met. The WTRU may delay transmission of some MAC CEs if they cause segmentation.

In some embodiments, if a second condition(s) is met or not met, the WTRU may deliver an SDU in whole to lower layers (e.g., to WTRU MAC) for TB construction and/or data multiplexing for transmission. If a second condition(s) is met or not met, the WTRU may keep the SDU in the buffer (e.g., a data flow buffer). If a third condition(s) is met or not met, the WTRU may deliver a segment of the SDU and may allocate resources in a grant for the segment. If a second condition is met or not met, the WTRU may deliver a segment of the SDU to lower layers at the WTRU for transmission and/or data multiplexing. The first, second, and third conditions may be any of the following selective segmentation conditions or any combination thereof.

A selective segmentation condition may be that a remaining time associated with the SDU is less than or greater than a configured threshold, wherein the remaining time may be determined by the WTRU as the time until the flow's PDB is exhausted or the time until a discard timer associated with the packet expires, wherein the discard timer may be maintained at higher layers (e.g., PDCP).

A selective segmentation condition may be that the TBS of the grant(s) is less than or greater than a given configured threshold.

A selective segmentation condition may be that one or more QoS classification condition is met.

A selective segmentation condition may be that the SDU is from a subset of data flow(s) wherein the data flows may be configured.

A selective segmentation condition may be that the SDU does not require segmentation at higher layers (e.g., above MAC layer). The WTRU may determine that a SDU is subject to segmentation as a function of the data type, data flow, whether the SDU fits within a given resource allocation, whether the SDU size is greater than a threshold number of bits, or any combination thereof.

A selective segmentation condition may be that the SDU size is larger than the TBS of the grant, or that the SDU size is larger than the remaining number of bits that have not been allocated in the uplink grant.

A selective segmentation condition may be that the SDU is a data SDU, a control SDU, contains system information, contains a control SDU for a higher layer, of a data collection type (e.g., for machine learning/training), of a sensory data type, or any combination thereof.

A selective segmentation condition may be that the SDU belongs to a flow that is configured (or not configured) for segmentation permissibility.

A selective segmentation condition may be that the SDU belongs to a data type or QoS class that is configured or predefined with allowable segmentation.

A selective segmentation condition may be that the SDU segment size is known to the network (e.g., based on a previously transmitted/acknowledged segments of the same SDU).

A selective segmentation condition may be that the SDU segment size is the first, last, or a middle segment of an SDU.

A selective segmentation condition may be that the SDU is a retransmission of a previously transmitted SDU segment (e.g., it is a segment of segment or not).

A selective segmentation condition may be that the SDU segment is being retransmitted by HARQ and the number of HARQ retransmissions is greater than or less than a configured threshold.

A selective segmentation condition may be that the SDU is ahead in the data flow buffer of delay critical SDU in the same queue, wherein delay criticality may be determined based on the remaining time.

A selective segmentation condition may be based on measured channel conditions being less than or greater than a threshold.

A selective segmentation condition may be based on a combination of channel conditions and TBSs being greater than or less than configured thresholds.

A selective segmentation condition may be based on the WTRU power headroom or uplink transmit power (e.g., being below or above a threshold). For example, the WTRU may segment an SDU if its power headroom is less than a threshold or its transmit power is greater than another configured threshold. The reasoning is that “small grant” with “low PHR” may mean that the WTRU is in a coverage-limited (e.g., channel conditions are measured below a threshold) scenario, segmentation is justified and a conditions can be considered as met. If an uplink grant is available and it is small (e.g., TBS is less than a threshold) and channel conditions are above a threshold (e.g., in good channel conditions), it may be better to include a small SDU in that grant instead of segmenting a big SDU, as it could be expected that the network could give you a bigger grant later.

A selective segmentation condition may be an inclusion condition or any combination thereof.

A selective segmentation condition may be based on a further uplink grant being available to the WTRU upon processing the given uplink grant. The further uplink grant may also need to satisfy a condition to be regarded as a further uplink grant, for example, is available within a time limit (e.g., from the end of the current grant that is evaluated), has grant size/TBS that is greater than a threshold, is permitted to multiplex the data of the SDU (e.g., permitted by LCH restrictions), meets the scheduling properties of the current grant under evaluation, meets the physical layer transmission characteristics of the current grant under evaluation (e.g., MCS, reliability level, priority, MIMO layers), or any combination thereof.

A selective segmentation condition may be that a configuration on whether to segment or not is received per data type, data flow, and/or PDU set. A selective segmentation condition may be that WTRU has received an indication from the network to allow segmentation or not for a given data flow, LCH, LCG, SDU, and/or PDU set. The indication can be an indication by DCI, a MAC CE, or derived from a property of the scheduling. The indication can be specific to a grant, UE, a period of time, a data flow, an LCH/LCG, and/or a specific data type. The indication to apply segmentation or not may be applied for a period of time that is configured.

A selective segmentation condition may be that the WTRU has received an indication from the network (e.g., by a MAC CE or DCI) that another grant will be available, is available, or is to be scheduled, potentially with a given size that is less than or greater than a given threshold.

In some embodiments, the WTRU may allocate UL resources of an available grant (e.g., in LCP) to a MAC CE if a condition is met, where the condition includes at least one of the following MAC CE inclusion conditions.

A MAC CE inclusion condition may be that the MAC CE is of a certain type (e.g., PHR, BSR, BFR, DSR).

A MAC CE inclusion condition may be that the MAC CE is of a certain priority (e.g., a priority above or below a configured threshold). The configured threshold may be determined based on the priority of data in the LCP procedure. The priority of a MAC CE may be determined from a predefined prioritization list (which may prioritize data and other control elements) or may be configured.

A MAC CE inclusion condition may be that the MAC CE is configured or predefined to be included regardless of segmentation implications.

A MAC CE inclusion condition may be that an additional SDU is not segmented by the inclusion of the MAC CE. For example, for a MAC CE that is potentially assigned resources on an uplink grant after other data (e.g., other system, control, or user plane data), the WTRU may include the MAC CE only if the inclusion does not cause the segmentation of another SDU that would have been (or already have been) allocated to the grant. The additional SDU may be conditioned to be of a certain data/control flow, a data type, or one that meets any of the selective segmentation conditions.

A MAC CE inclusion condition may be whether the MAC CE is a triggered MAC CE (e.g., pending for transmission and has been initiated by a MAC procedure for transmission), and may be based on a subset of triggers that are event based or based on a subset of triggers that are based on periodic transmission. Some MAC CEs may have both periodic triggers and event-like triggers (e.g., BSR, PHR).

A MAC CE inclusion condition may be whether SR was triggered to obtain an uplink grant/resources for transmitting the MAC CE. In such cases, if a grant is received to transmit a given MAC CE, the WTRU may include the MAC CE without checking conditions for MAC CE inclusion.

A MAC CE inclusion condition may be whether a selective segmentation condition, or any combination thereof, is met.

A MAC CE inclusion condition may be based on a further uplink grant being available to the WTRU upon processing the given uplink grant. The further uplink grant may need to satisfy a condition to be regarded as a further uplink grant. For example, the further uplink grand may need to be available within a time limit (e.g., from the end of the current grant that is evaluated), has grant size/TBS that is greater than a threshold, is permitted to multiplex the data of the SDU (e.g., permitted by LCH restrictions), meets the scheduling properties of the current grant under evaluation, meets the physical layer transmission characteristics of the current grant under evaluation (e.g., MCS, reliability level, priority, MIMO layers), or any combination thereof.

In some embodiments, in scenarios in which the WTRU has a multitude of uplink grants, the WTRU may evaluate inclusion conditions, selective segmentation conditions, and/or MAC CE inclusion conditions on the union of available uplink grants, sequentially on a grant per grant basis, or in parallel considering all available uplink grants. In some embodiments, the WTRU may only evaluate uplink grants within an evaluation window that is configured by upper layers, wherein only grants within a window from the evaluation instance are considered. For example, the WTRU may receive a DCI that indicates a multitude of grants or when available grants are within a time window. The WTRU may run LCP and evaluate such conditions on all grants considered. In some embodiments, the WTRU may have a grant at instance x of L bits and another grant at instance y of 4L bits. The WTRU may forgo multiplexing an SDU of size L or even L/2 in the first grant and may instead multiplex it on the second grant at instance y.

In some embodiments, the WTRU may skip (not perform) RLC processing (if present in the UP protocol stack) for packets that are not segmented, including UM and AM RLC entities, whereby the packet is treated as if it is an SDU from a transparent mode RLC entity.

In accordance with some embodiments of this disclosure, methods and systems for control of segmentations of segments are provided as follows.

In some embodiments, the WTRU may conditionally perform Automatic Repeat Request (ARQ) for retransmission of a data unit (including a packet, an SDU, and/or a segment of an SDU), whereby ARQ is conditioned on meeting one or more inclusion conditions, selective segmentation conditions, and/or MAC CE inclusion conditions described herein. The conditions may be evaluated per retransmitted SDU or per segment of the retransmitted SDU.

In some embodiments, the WTRU may be configured with a maximum number of segments of an SDU segment, wherein the WTRU does not re-segment beyond this maximum number of segments of segments (e.g., the depth of a segmentation tree). The configuration of maximum number of segments of an SDU segment may be configured per SDU size or SDU size range, data flow, data type, QoS class, or any combination thereof.

In some embodiments, the WTRU may be configured with a maximum number of segments of an SDU, whereby the WTRU does not segment the SDU beyond this maximum number. The configuration of maximum number be configured per SDU size or SDU size range, data flow, data type, QoS class, or any combination thereof.

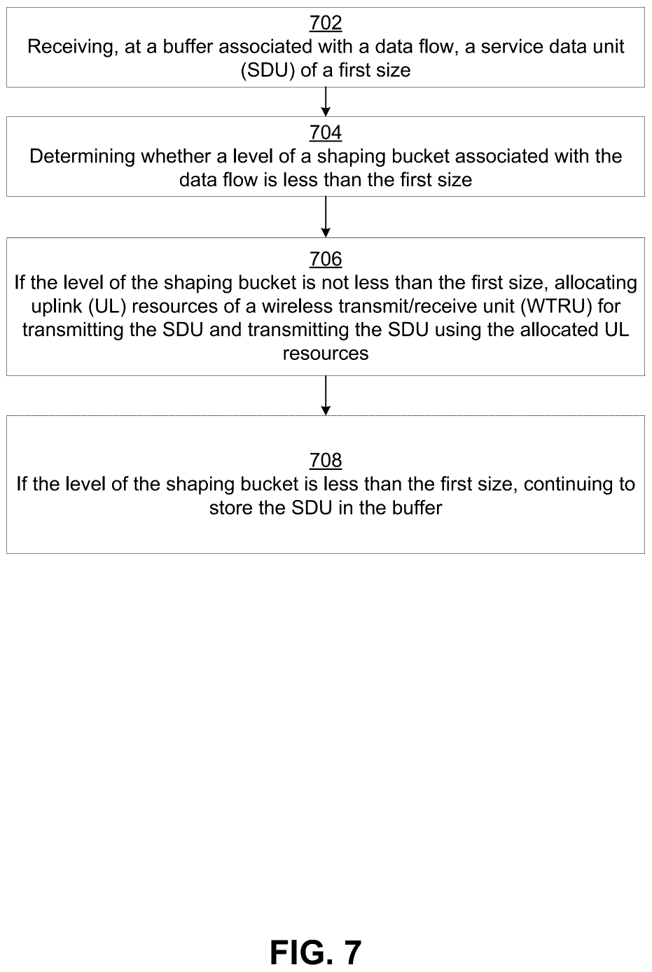

FIG. 7 is an illustrative flow diagram of steps for controlled segmentation and traffic shaping, according to some embodiments of this disclosure.

At step 702, a WTRU (e.g., any WTRU 102) may receive, at a buffer associated with a data flow, a SDU of a first size.

At step 704, the WTRU may determine whether a level of a shaping bucket associated with the data flow is less than the first size.

In some embodiments, the shaping bucket is a first shaping bucket and the level is a first level. The buffer may be one of a plurality of buffers each storing data associated with a plurality of respective data flows. Respective SDUs of the plurality of buffers may be of respective sizes that are greater than respective levels of respective shaping buckets associated with the plurality of data flows. The WTRU may (a) eliminate at least one data flow of the plurality of data flows based on at least one criterion. The WTRU may (b) allocate a second level of a shaping bucket associated with the eliminated at least one data flow to at least one shaping bucket of remaining data flows of the plurality of data flows causing a respective resultant level of the at least one shaping bucket of the remaining data flows to be greater than or equal to the respective sizes of the respective SDUs of the remaining data flows. The WTRU may (c) transmit SDUs associated with the at least one shaping bucket of the remaining data flows based on allocating the second level of the shaping bucket of the eliminated at least one data flow to the at least one shaping bucket of the remaining data flows.

In some embodiments, the at least one criterion comprises at least one of: data flow with least shaping bucket level, data flow with largest gap between its associated SDU size and shaping bucket level, data flow of least priority, or data flow with most remaining time with its associated data.

In some embodiments, the WTRU may repeat steps (a)-(c) until all SDUs associated with the plurality of data flows are transmitted without segmentation.

At step 706, if the level of the shaping bucket is not less than the first size, the WTRU may allocate UL resources of the WTRU for transmitting the SDU and transmit the SDU using the allocated UL resources.

In some embodiments, the UL resources are first UL resources. The WTRU may allocate second UL resources of the WTRU to a MAC control element (CE) for transmitting the at least a segment of the SDU based on at least one additional condition.

In some embodiments, the at least one additional condition comprises at least one of: the MAC CE is of a certain type, the MAC CE is of a certain priority, the MAC CE is configured to be included regardless of segmentation implications, or an additional SDU would not be caused to be segmented by using the MAC CE for the SDU.

In some embodiments, UL resources comprise bit allocation in a TB.

At step 708, if the level of the shaping bucket is less than the first size, the WTRU may continue to store the SDU in the buffer.

In some embodiments, continuing to store the SDU in the buffer comprises continuing to store the SDU in the buffer unless at least one condition is met. The WTRU may deliver at least a segment of the SDU to a MAC layer of the WTRU.

In some embodiments, the at least one condition comprises at least one of: a remaining time until expiration associated with the SDU exceeds a threshold, one or more conditions based on one or more QoS classes, the SDU is from a configured data flow, the SDU does not require segmentation at layers above the MAC layer, the first size is larger than a TBS of UL resources, a condition based on a type of data in SDU, or additional UL resources becoming available.

In some embodiments, continuing to store the SDU in the buffer comprises continuing to store the SDU in the buffer until the level of the shaping buffer is at least the first size.

Although features and elements are provided above in particular combinations, one of ordinary skill in the art will appreciate that each feature or element may be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments may be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that may be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that may cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range may be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which may be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

What is claimed is:

1. A method performed by a traffic scheduling regulator of a wireless transmit/receive unit (WTRU), the method comprising:
receiving, at a buffer associated with a data flow, a service data unit (SDU) of a first size;
determining whether a level of a shaping bucket associated with the data flow is less than the first size;
if the level of the shaping bucket is not less than the first size, allocating uplink (UL) resources of the WTRU for transmitting the SDU and transmitting the SDU using the allocated UL resources; and
if the shaping bucket level is less than the first size, continuing to store the SDU in the buffer.

2. The method of claim 1, wherein:
the shaping bucket is a first shaping bucket and the level is a first level;
the buffer is one of a plurality of buffers each storing data associated with a plurality of respective data flows, and wherein respective SDUs of the plurality of buffers are of respective sizes that are greater than respective levels of respective shaping buckets associated with the plurality of data flows, the method further comprising:
(a) eliminating at least one data flow of the plurality of data flows based on at least one criterion,
(b) allocating a second level of a shaping bucket associated with the eliminated at least one data flow to at least one shaping bucket of remaining data flows of the plurality of data flows causing a respective resultant level of the at least one shaping bucket of the remaining data flows to be greater than or equal to the respective sizes of the respective SDUs of the remaining data flows, and
(c) transmitting SDUs associated with the at least one shaping bucket of the remaining data flows based on allocating the second level of the shaping bucket of the eliminated at least one data flow to the at least one shaping bucket of the remaining data flows.

3. The method of claim 2, wherein the at least one criterion comprises at least one of: data flow with least shaping bucket level, data flow with largest gap between its associated SDU size and shaping bucket level, data flow of least priority, or data flow with most remaining time with its associated data.

4. The method of claim 2, further comprising repeating steps (a)-(c) until all SDUs associated with the plurality of data flows are transmitted without segmentation.

5. The method of claim 1, wherein continuing to store the SDU in the buffer comprises continuing to store the SDU in the buffer unless at least one condition is met, the method further comprising delivering at least a segment of the SDU to a medium access control (MAC) layer of the WTRU.

6. The method of claim 4, wherein the at least one condition comprises at least one of: a remaining time until expiration associated with the SDU exceeds a threshold, one or more conditions based on one or more quality of service (QoS) classes, the SDU is from a configured data flow, the SDU does not require segmentation at layers above the MAC layer, the first size is larger than a transport block size (TBS) of UL resources, a condition based on a type of data in SDU, or additional UL resources becoming available.

7. The method of claim 4, wherein the UL resources are first UL resources, the method further comprising allocating second UL resources of the WTRU to a MAC control element (CE) for transmitting the at least a segment of the SDU based on at least one additional condition.

8. The method of claim 6, wherein the at least one additional condition comprises at least one of: the MAC CE is of a certain type, the MAC CE is of a certain priority, the MAC CE is configured to be included regardless of segmentation implications, or an additional SDU would not be caused to be segmented by using the MAC CE for the SDU.

9. The method of claim 1, wherein continuing to store the SDU in the buffer comprises continuing to store the SDU in the buffer until the level of the shaping buffer is at least the first size.

10. The method of claim 1, wherein UL resources comprises bit allocation in a transport block (TB).

11. A wireless transmit/receive unit (WTRU) that is in communication with a wireless network, the WTRU comprising a processor and a transceiver, wherein the WTRU is configured to:
receive, at a buffer associated with a data flow, a service data unit (SDU) of a first size;
determine whether a level of a shaping bucket associated with the data flow is less than the first size;
if the level of the shaping bucket is not less than the first size, allocate uplink (UL) resources of the WTRU for transmitting the SDU and transmit the SDU using the allocated UL resources; and
if the shaping bucket level is less than the first size, continue to store the SDU in the buffer.

12. The WTRU of claim 11, wherein:
the shaping bucket is a first shaping bucket and the level is a first level;
the buffer is one of a plurality of buffers each storing data associated with a plurality of respective data flows, and wherein respective SDUs of the plurality of buffers are of respective sizes that are greater than respective levels of respective shaping buckets associated with the plurality of data flows, the WTRU configured to:
(a) eliminate at least one data flow of the plurality of data flows based on at least one criterion,
(b) allocate a second level of a shaping bucket associated with the eliminated at least one data flow to at least one shaping bucket of remaining data flows of the plurality of data flows causing a respective resultant level of the at least one shaping bucket of the remaining data flows to be greater than or equal to the respective sizes of the respective SDUs of the remaining data flows, and
(c) transmit SDUs associated with the at least one shaping bucket of the remaining data flows based on allocating the second level of the shaping bucket of the eliminated at least one data flow to the at least one shaping bucket of the remaining data flows.

13. The WTRU of claim 12, wherein the at least one criterion comprises at least one of: data flow with least shaping bucket level, data flow with largest gap between its associated SDU size and shaping bucket level, data flow of least priority, or data flow with most remaining time with its associated data.

14. The WTRU of claim 12, configured to repeat steps (a)-(c) until all SDUs associated with the plurality of data flows are transmitted without segmentation.

15. The WTRU of claim 11, wherein continuing to store the SDU in the buffer comprises continuing to store the SDU in the buffer unless at least one condition is met, the WTRU configured to deliver at least a segment of the SDU to a medium access control (MAC) layer of the WTRU.

16. The WTRU of claim 14, wherein the at least one condition comprises at least one of: a remaining time until expiration associated with the SDU exceeds a threshold, one or more conditions based on one or more quality of service (QoS) classes, the SDU is from a configured data flow, the SDU does not require segmentation at layers above the MAC layer, the first size is larger than a transport block size (TBS) of UL resources, a condition based on a type of data in SDU, or additional UL resources becoming available.

17. The WTRU of claim 14, wherein the UL resources are first UL resources, the WTRU configured to allocate second UL resources of the WTRU to a MAC control element (CE) for transmitting the at least a segment of the SDU based on at least one additional condition.

18. The WTRU of claim 16, wherein the at least one additional condition comprises at least one of: the MAC CE is of a certain type, the MAC CE is of a certain priority, the MAC CE is configured to be included regardless of segmentation implications, or an additional SDU would not be caused to be segmented by using the MAC CE for the SDU.

19. The WTRU of claim 11, wherein continuing to store the SDU in the buffer comprises continuing to store the SDU in the buffer until the level of the shaping buffer is at least the first size.

20. The WTRU of claim 11, wherein UL resources comprises bit allocation in a transport block (TB).
